(19) United States
(12) Patent Application Publication
(10) Pub. No.: US 2025/0043055 A1
(43) Pub. Date: Feb. 6, 2025

(54) GRAFTED POLYETHYLENE

(71) Applicant: Dow Global Technologies LLC, Midland, MI (US)

(72) Inventors: Santosh S. Bawiskar, Sugar Land, TX (US); Joshua Enokida, Houston, TX (US); Xiaofei Sun, Pearland, TX (US); Jeffrey C. Munro, Bellaire, TX (US); Bo Lyu, Zhejiang (CN); Barry A. Morris, Wilmington, DE (US); Rajesh P. Paradkar, Lake Jackson, TX (US); Jeffrey D. Weinhold, Lake Jackson, TX (US); Sean Ewart, Pearland, TX (US); Mou Paul, Pearland, TX (US)

(73) Assignee: Dow Global Technologies LLC, Midland, MI (US)

(21) Appl. No.: 18/717,192

(22) PCT Filed: Dec. 14, 2021
(86) PCT No.: PCT/CN2021/137810

§ 371 Date: Jun. 6, 2024

(51) Int. Cl. C08F 255/02; C08F 287/00

(52) U.S. Cl. CPC C08F 255/02; C08F 287/00

(57) ABSTRACT

Embodiments of a grafted polyethylene comprise a reaction product of a polyethylene having a melt index (at 190° C., 2.16 kg) of at least 0.75 g/10 min, from 0.5 wt. % to 10 wt. % of metal acrylate or metal methacrylate at least partially grafted on the polyethylene, and from 0.1 wt. % to 10 wt. % of one or more metal carboxylates, wherein the metal carboxylate does not have any terminal unsaturation.

### TECHNICAL FIELD

The present specification generally relates to polyethylene, and in particular, grafted polyethylene produced from metal acrylate or metal methacrylate at least partially grafted on the polyethylene, and metal carboxylates without any terminal unsaturation.

### BACKGROUND

Grafting of metal acrylates onto polyethylene is a conventionally known process, specifically for the grafting of ionomers. This is beneficial for processing as well as mechanical, adhesion and/or thermal properties. For these reasons, there is a continual need for improved grafts in various applications, such as flexible packaging.

### SUMMARY

Embodiments of the present disclosure meet this need and superior grafts can be made while grafting the metal acrylates or metal methacrylates in combination with metal carboxylates, which may act as dispersing agent and/or a catalyst. This synergistic combination of metal acrylates or metal methacrylates and metal carboxylates yields larger viscosity changes as compared to using a metal acrylate alone, and allows for less metal acrylate to be used for a given viscosity change, thereby increasing efficiency of the reaction.

Increased viscosity in comparison to the base ungrafted resin is an indication of the formation of ionomeric linkages. By introducing ionic crosslinks, desirable rheological changes in the polymer such as improved melt strength (high zero shear viscosity), temperature resistance, creep resistance, adhesion, abrasion resistance can be introduced.

According to one embodiment, the grafted polyethylene comprises a reaction product of a polyethylene having a melt index (at 190° C. 2.16 kg) of at least 0.75 g/10 min, from 0.5 wt. % to 10 wt. % of metal acrylate or metal methacrylate at least partially grafted on the polyethylene, and from 0.1 wt. % to 10 wt. % of one or more metal carboxylates, wherein the metal carboxylate does not have any terminal unsaturation.

Additional features and advantages will be set forth in the detailed description which follows, and in part will be readily apparent to those skilled in the art from that description or recognized by practicing the embodiments described herein, including the detailed description which follows and the claims.

It is to be understood that both the foregoing general description and the following detailed description describe various embodiments and are intended to provide an overview or framework for understanding the nature and character of the claimed subject matter.

### DETAILED DESCRIPTION

Specific embodiments of the present application will now be described. The disclosure may, however, be embodied in different forms and should not be construed as limited to the embodiments set forth in this disclosure. Rather, these embodiments are provided so that this disclosure will be thorough and complete, and will fully convey the scope of the subject matter to those skilled in the art.

### Definitions

The term “polymer” refers to a polymeric compound prepared by polymerizing monomers, whether of the same or a different type. The generic term polymer thus embraces the term “homopolymer,” usually employed to refer to polymers prepared from only one type of monomer as well as “copolymer” which refers to polymers prepared from two or more different monomers. The term “interpolymer.” as used herein, refers to a polymer prepared by the polymerization of at least two different types of monomers. The generic term interpolymer thus includes copolymers, and polymers prepared from more than two different types of monomers, such as terpolymers.

“Polyethylene” or “ethylene based polymer” shall mean polymers comprising greater than 50% by weight of units which have been derived from ethylene monomer. This includes polyethylene homopolymers or copolymers (meaning units derived from two or more comonomers). Comonomers may include olefin comonomers as well as polar comonomers. Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

The term “LDPE” may also be referred to as “high pressure ethylene polymer” or “highly branched polyethylene” and is defined to mean that the polymer is partly or entirely homopolymerized or copolymerized in autoclave or tubular reactors at pressures above 14.500 psi (100 MPa) with the use of free-radical initiators, such as peroxides (see for example U.S. Pat. No. 4,599,392, which is hereby incorporated by reference). LDPE resins typically have a density in the range of 0.916 grams per cubic centimeter (g/cc) to 0.935 g/cc.

The term “LLDPE”, includes resin made using Ziegler-Natta catalyst systems as well as resin made using single-site catalysts, including, but not limited to, bis-metallocene catalysts (sometimes referred to as “m-LLDPE”) and constrained geometry catalysts, and resin made using post-metallocene, molecular catalysts. LLDPE includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045). The LLDPE resins can be made via gas-phase, solution-phase or slurry polymerization or any combination thereof, using any type of reactor or reactor configuration known in the art.

The term “MDPE” refers to polyethylenes having densities from 0.926 to 0.940 g/cc. “MDPE” is typically made using chromium or Ziegler-Natta catalysts or using single-site catalysts including, but not limited to, bis-metallocene catalysts and constrained geometry catalysts.

The term “HDPE” refers to polyethylenes having densities greater than about 0.940 g/cc, which are generally prepared with Ziegler-Natta catalysts, chrome catalysts or single-site catalysts including, but not limited to, bis-metallocene catalysts and constrained geometry catalysts.

The term “olefin block copolymer” or “OBC” refers to an ethylene/alpha-olefin multi block interpolymer and includes ethylene and one or more copolymerizable alpha-olefin comonomers in polymerized form, characterized by multiple blocks or segments of two or more (preferably three or more) polymerized monomer units, the blocks or segments differing in chemical or physical properties. Specifically, the term“olefin block copolymer” refers to a polymer comprising two or more (preferably three or more) chemically distinct regions or segments (referred to as“blocks”) joined in a linear manner, that is, a polymer comprising chemically differentiated units which are joined (covalently bonded) end-to-end with respect to polymerized functionality, rather than in pendent or grafted fashion. The blocks differ in the amount or type of comonomer incorporated therein, the density, the amount of crystallinity, the type of crystallinity (e.g., polyethylene versus polypropylene), the crystallite size attributable to a polymer of such composition, the type or degree of tacticity (isotactic or syndiotactic), region-regularity or region-irregularity, the amount of branching, including long chain branching or hyper-branching, the homogeneity, and/or any other chemical or physical property. The block copolymers are characterized by unique distributions of both polymer polydispersity (PDI or Mw/Mn) and block length distribution, e.g., based on the effect of the use of a shuttling agent(s) in combination with catalyst systems. Non-limiting examples of the olefin block copolymers of the present disclosure, as well as the processes for preparing the same, are disclosed in U.S. Pat. Nos. 7,858,706 B2, 8,198,374 B2, 8,318,864 B2, 8,609,779 B2, 8,710,143 B2, 8,785,551 B2, and 9,243,090 B2, which are all incorporated herein by reference in their entirety. As used in the present disclosure, the terms “blend” or “polymer blend,” as used, refer to a mixture of two or more polymers. A blend may or may not be miscible (phase separated at the molecular level). A blend may or may not be phase separated. A blend may or may not contain one or more domain configurations, as determined from transmission electron spectroscopy, light scattering, x-ray scattering, and other methods known in the art. The blend may be prepared by physically mixing the two or more polymers on the macro level (for example, melt blending resins or compounding) or the micro level (for example, simultaneous forming within the same reactor). It is possible to prepare the blends in a melt phase or using solution blending in a common solvent.

As used in the present disclosure, the term “ionomer” refers to a polymer that comprises repeat units of both electrically neutral repeating units and a fraction of ionized units covalently bonded to the polymer backbone as pendant moieties.

The terms “comprising.” “including,” “having.” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

Embodiments of the present disclosure are directed to a grafted polyethylene comprise a polyethylene having a melt index (at 190° C., 2.16 kg) of at least 0.75 g/10 min; from 0.5 wt. % to 10 wt. % of metal acrylate or metal methacrylate at least partially grafted on the polyethylene; and from 0.1 wt. % to 10 wt. % of one or more metal carboxylates, wherein the metal carboxylate does not have any terminal unsaturation.

### Metal Acrylate

Various metals are considered suitable for the metal acrylate or metal methacrylate of the present disclosure. For example, the metal of the metal acrylate or metal methacrylate may comprise zinc, sodium, magnesium, potassium, lithium or combinations thereof. In further embodiments, the metal acrylate may comprise zinc diacrylate or sodium acrylate. In one embodiment, the metal acrylate or metal methacrylate may be generated in-situ. As an example acrylic acid and zinc oxide may be used to generate zinc diacrylate or methacrylic acid and zinc oxide may be used to generate zinc dimethacrylate in-situ.

In one or more embodiments, 0.5 wt. % to 10 wt. % of metal acrylate or metal methacrylate, from 2 to 8 wt. %, or from 2 to 5 wt. % may be grafted onto the polyethylene based on the total weight of the polyethylene and grafted acrylate.

### Metal Carboxylate

Similarly, the metal carboxylate, which does not include any terminal unsaturation, may comprise various suitable metals, such as zinc, sodium, magnesium, calcium, potassium, tin, lithium, or combinations thereof. The metal carboxylate may comprise a hydrocarbon chain of at least 8 carbons, at least 12 carbons, at least 16 carbons, or at least 18 carbons. In embodiments, the metal carboxylate comprises metal stearates, metal laurates, metal octoates, or combinations thereof. In further embodiments, the metal carboxylate comprises zinc stearate, zinc laurate, zinc octoate, dibutyltin dilaurate, or combinations thereof.

In one or more embodiment, from 0.1 wt. % to 10 wt. % of one or more metal carboxylates, or from 1 to 5 wt. % of metal carboxylates may be used.

Without being bound by theory, the metal acrylates are the grafting agents for the polyethylene and the metal carboxylates are the dispersing agents and/or catalysts that achieve improved grafting of the acrylate onto the polyethylene.

The grafting onto the polyethylene may utilize free radical initiators, which generate free radicals. Graft polymerization may be conducted in the presence of a free radical generator such as an organic peroxide (e.g., alkyl peroxides) or an azo compound. Ultrasound or ultraviolet irradiation or by any high energy radiation can be used to generate free radicals. The acrylate may, alternatively or additionally, be grafted onto the polyolefin using thermal grafting. Thermal grafting may refer to grafting accomplished using shear and heat using an extruder or a high shear mixer.

A free-radical initiator, as used herein, refers to a free radical generated by chemical and/or radiation means. There are several types of compounds that can initiate grafting reactions by decomposing to form free radicals, including azo-containing compounds, carboxylic peroxyacids and peroxyesters, alkyl hydroperoxides, and dialkyl and diacyl peroxides, among others. Many of these compounds and their properties have been described (Reference: J. Branderup, E. Immegut. E. Grulke, eds. “Polymer Handbook,” 4th ed., Wiley, New York, 1999, Section II, pp. 1-76.). It is preferable for the species that is formed by the decomposition of the initiator to be an oxygen-based free radical. It is more preferable for the initiator to be selected from carboxylic peroxyesters, peroxyketals, dialkyl peroxides, and diacyl peroxides. Organic initiators are preferred, such as any one of the peroxide initiators, for example, dicumyl peroxide, di-tert-butyl peroxide, t-butyl perbenzoate, benzoyl peroxide, cumene hydroperoxide, t-butyl peroctoate, methyl ethyl ketone peroxide, 2,5-dimethyl-2,5-di(tert-butyl peroxy) hexane, lauryl peroxide, and tert-butyl peracetate, t-butyl alpha-cumyl peroxide, di-t-butyl peroxide, di-t-amyl peroxide, t-amyl peroxybenzoate, 1,1-bis(t-butylperoxy)-3,3,5-trim-ethylcyclohexane, alpha,alpha′-bis(t-butylperoxy)-1,3-diisopropyl-benzene, alpha,alpha′-bis(t-butylperoxy)-1,4-diisopropyl-benzene, 2,5-bis(t-butylperoxy)-2,5-dimethylhexane, and 2,5-bis(t-butylperoxy)-2,5-dimethyl-3-hexyne. A suitable azo compound is azobisisobutyl nitrite.

### Polyethylene

Various options are considered suitable for the polyethylene. For example, the polyethylene may comprise high density polyethylene (HDPE). The HDPE may have a density from 0.940 g/cc to 0.980 g/cc, from 0.945 g/cc to 0.965 g/cc, or from 0.950 g/cc to 0.965 g/cc. Moreover, the HDPE may comprise a melt index of 0.5 to 100 g/10 mins, from 5 to 80 g/10 mins, from 5 to 50 g/10 mins, from 50 to 10 g/10 mins, from 50 to 80 g/10 mins, or from 55 to 75 g/10 mins as measured according to ASTM D1238 (2.16 kg/190° C.).

As noted above, the grafting provides increased viscosity for the polyethylene, which may be reflected by higher viscosity at a shear rate of 0.1 s⁻¹ and 190° C. (V0.1). In many cases, the synergistic combination of metal acrylate and metal carboxylate may at least double the V0.1 viscosity of the grafted HDPE by at least two times relative to a graft on the HDPE produced by metal acrylate alone. Moreover, “rheology ratio” may refer to the ratio of the viscosity measured at a shear rate of 0.1 s⁻¹ and 190° C. to the viscosity measured at 100 s⁻¹ and 190° C. After grafting, the HDPE may exhibit a rheology ratio (V0.1/V100) greater than 25.

In further embodiments, the polyethylene comprises an olefin block copolymer (OBC). The OBC may have a density from 0.850 g/cc to 0.900 g/cc, from 0.855 g/cc to 0.895 g/cc, or from 0.860 g/cc to 0.890 g/cc. Moreover, the OBC may comprise a melt index of 0.5 to 50 g/10 mins, from 1 to 30 g/10 mins, from 2 to 25 g/10 mins, or from 4 to 20 g/10 mins as measured according to ASTM D1238 (2.16 kg/190° C.).

Moreover, the synergistic combination of metal acrylate and metal carboxylate may at least double the V0.1 viscosity of the grafted OBC by at least three times relative to a graft produced by metal acrylate alone. Moreover, the OBC may exhibit a rheology ratio (V0.1/V100) greater than 25.

In further embodiments, the polyethylene comprises a polyolefin elastomer (POE). As defined herein, a polyolefin elastomer is an ethylene/alpha-olefin interpolymer wherein alpha-olefin is preferably a C₃-C₂₀ aliphatic compound, and more preferably C₃-C₁₀ aliphatic compound. Preferred C₃-C₁₀ aliphatic alpha-olefins included propylene, 1-butene, 1-hexene. 1-octene, and 1-decene, and more preferably 1-octene. The term “ethylene-alpha-olefin interpolymer” refers to a random interpolymer that comprises, in polymerized form, ethylene and an alpha-olefin.

The POE may have a density from 0.840 g/cc to 0.900 g/cc, from 0.850 g/cc to 0.875 g/cc, or from 0.860 g/cc to 0.890 g/cc. Moreover, the POE may comprise a melt index of 0.1 to 5.0 g/10 mins. from 0.5 to 2.5 g/10 mins, or from 0.75 to 1.5 g/10 mins as measured according to ASTM D1238 (2.16 kg/190° C.). Moreover, the synergistic combination of metal acrylate and metal carboxylate may at least double the V0.1 viscosity of the grafted POE by at least three times relative to a graft produced by metal acrylate alone.

Moreover, the polyethylene may comprises a polar ethylene copolymer having a structure E/X/Y, wherein the E is ethylene, X is selected from α,β-unsaturated C₃-C₈ carboxylic acid, alkyl acrylate, and vinyl acetate, The X may comprise 0 to 40 wt. %, from 0.1 to 40 wt. %, or from 1 to 25 wt. % of the polar ethylene copolymer. Examples of “X” may include acrylic acid, methacrylic acid, ethacrylic acid, itaconic acid, maleic acid, fumaric acid, monoesters of said dicarboxylic acids, such as methyl hydrogen maleate, methyl hydrogen fumarate, ethyl hydrogen fumarate and maleic anhydride.

The “Y” of the E/X/Y ethylene interpolymer may be an optional comonomer comprising alkyl acrylate (e.g., C₁-C₈ alkyl acrylate), α,β-unsaturated C₃-C₈ carboxylic acid, and carbon monoxide. Alkyl acrylate may include but are not limited to ethyl acrylate, methyl acrylate, n-butyl acrylate, iso-butyl acrylate, or combinations of these.

In one embodiment, the polar ethylene copolymer comprises ethylene alkyl acrylate copolymer i.e., X is alkyl acrylate. The ethylene alkyl acrylate copolymer may have a density from 0.900 g/cc to 0.945 g/cc, from 0.910 g/cc to 0.940 g/cc, or from 0.920 g/cc to 0.940 g/cc. Moreover, the ethylene alkyl acrylate copolymer may comprise a melt index of 1.0 to 50 g/10 mins, from 5 to 40 g/10 mins, from 10 to 40 g/10 mins, or from 20 to 30 g/10 mins as measured according to ASTM D1238 (2.16 kg/190° C.). In one or more embodiments, the ethylene alkyl acrylate copolymer may comprise from 1 to 40 wt. % alkyl acrylate monomer, from 5 to 35 wt. % alkyl acrylate monomer, from 10 to 30 wt. % alkyl acrylate monomer, or from 15 to 25 wt. % alkyl acrylate monomer.

In one embodiment, the polar ethylene copolymer comprises ethylene α,β-unsaturated C₃-C₈ carboxylic acid copolymer i.e., the X is α,β-unsaturated C₃-C₈ carboxylic acid. The ethylene α,β-unsaturated C₃-C₈ carboxylic acid copolymer may have a density from 0.900 g/cc to 0.975 g/cc, from 0.925 g/cc to 0.950 g/cc, or from 0.935 g/cc to 0.945 g/cc. Moreover, the ethylene α,β-unsaturated C₃-C₈ carboxylic acid copolymer may comprise a melt index of 1.0 to 100 g/10 mins, from 20 to 80 g/10 mins, from 30 to 75 g/10 mins, or from 50 to 70 g/10 mins as measured according to ASTM D1238 (2.16 kg/190° C.). In one or more embodiments, the ethylene α,β-unsaturated C₃-C₈ carboxylic acid copolymer may comprise from 1 to 40 wt. % α,β-unsaturated C₃-C₈ carboxylic acid acrylate monomer, from 5 to 35 wt. % α,β-unsaturated C₃-C₈ carboxylic acid acrylate monomer, from 10 to 30 wt. % α,β-unsaturated C₃-C₈ carboxylic acid acrylate monomer, or from 15 to 25 wt. % α,β-unsaturated C₃-C₈ carboxylic acid acrylate monomer.

In one embodiment, the polar ethylene copolymer comprises an ionomer, the ionomer being the ethylene α,β-unsaturated C₃-C₈ carboxylic acid copolymer at least partially neutralized by metal cation. Typical cation sources include sodium hydroxide, sodium carbonate, sodium acetate, zinc oxide, zinc acetate, magnesium hydroxide, and lithium hydroxide. Other ion sources are well known and will be appreciated by those skilled in the art. In addition to the sodium, zinc, magnesium, and lithium ions, other alkali metal or alkaline earth metal cations are useful and may include potassium, calcium, tin, lead, aluminum, and barium. A combination of ions may also be used. It is contemplated that the neutralization may occur via metal salts with or without a catalyst. Catalysts such as water or acetic acid may be used.

It is contemplated that the degree of neutralization may be dependent on the desired application. As used in the present disclosure, the “degree of neutralization” may refer to the amount of acid sites that are neutralized by a metal salt. The degree of neutralization may be based on the amount of acid sites on the polyethylene. In embodiments, the degree of neutralization may be from 15% to 90%, from 15% to 80%, from 15% to 70%, from 15% to 60%, from 15% to 50%, from 15% to 40%, from 15% to 30%, from 15% to 20%, from 25% to 90%, from 25% to 80%, from 25% to 70%, from 25% to 60%, from 25% to 50%, from 25% to 40%, from 25% to 30%, from 35% to 90%, from 35% to 80%, from 35% to 70%, from 35% to 60%, from 35% to 50%, from 35% to 40%, from 45% to 90%, from 45% to 80%, from 45% to 70%, from 45% to 60%, from 45% to 50%, from 55% to 90%, from 55% to 80%, from 55% to 70%, from 55% to 60%, from 65% to 90%, from 65% to 80%, from 65% to 70%, from 75% to 90%, from 75% to 80%, or from 85% to 90%.

In further embodiments, the polar ethylene copolymer comprises ethylene vinyl acetate copolymer i.e., X is vinyl acetate. The ethylene vinyl acetate copolymer may have a density from 0.925 g/cc to 0.975 g/cc, from 0.950 g/cc to 0.975 g/cc, or from 0.960 g/cc to 0.970 g/cc. Moreover, the ethylene vinyl acetate copolymer may comprise a melt index of 1.0 to 100 g/10 mins, from 20 to 80 g/10 mins, or from 40 to 60 g/10 mins as measured according to ASTM D1238 (2.16 kg/190° C.). In one or more embodiments, the ethylene vinyl acetate copolymer may comprise from 0.1 to 40 wt. % vinyl acetate monomer, from 1 to 30 wt. % vinyl acetate monomer, or from 5 to 30 wt. % vinyl acetate monomer.

Moreover, the polar ethylene copolymer may comprise ethylene vinyl acetate carbon monoxide terpolymer i.e., X is vinyl acetate and Y is carbon monoxide. Moreover, the ethylene vinyl acetate carbon monoxide terpolymer may comprise a melt index from 10 to 50 g/10 mins, as measured according to ASTM D1238 (2.16 kg/190° C.). In one or more embodiments, the ethylene vinyl acetate carbon monoxide terpolymer may comprise from 0.1 to 40 wt. % vinyl acetate monomer, from 1 to 30 wt. % vinyl acetate monomer, or from 5 to 30 wt. % vinyl acetate monomer. In one or more embodiments, the ethylene vinyl acetate carbon monoxide terpolymer may comprise from 0.1 to 40 wt. % carbon monoxide monomer, from 1 to 30 wt. % carbon monoxide monomer, or from 5 to 30 wt. % carbon monoxide monomer.

The synergistic combination of metal acrylate and metal carboxylate increases the V0.1 viscosity of the grafted polar ethylene copolymers relative to a graft produced by metal acrylate alone.

Various processes for producing the grafted polyethylene are contemplated. The polyethylene, the metal acrylate or metal methacrylate, and the metal carboxylate may be blended in a batch or continuous mixer to produce the grafted polyethylene. The metal acrylate or metal methacrylate may be fed as a powder or as a masterbatch. Some examples of continuous equipment that can be used include co-rotating or counter-rotating twin screw extruders, single screw extruders, continuous mixers, reciprocating kneaders, and multi screw extruders. Some examples of batch mixers are a two-roll mill, intermeshing, or non-intermeshing internal mixers.

### Additives

The grafted polyethylene compositions can additionally include small amounts of additives including plasticizers, stabilizers including viscosity stabilizers, flame retardants, hydrolytic stabilizers, primary and secondary antioxidants, ultraviolet light absorbers, anti-static agents, dyes, pigments or other coloring agents, inorganic fillers, fire-retardants, lubricants, reinforcing agents such as glass fiber and flakes, synthetic (for example, aramid) fiber or pulp, foaming or blowing agents, processing aids, slip additives, antiblock agents such as silica or talc, release agents, tackifying resins, or combinations of two or more thereof. Inorganic fillers, such as calcium carbonate, and the like can also be incorporated into the polymer blends and ionomer compositions.

These additives may be present in quantities ranging from 0.01 wt. % to 40 wt. %, 0.01 to 25 wt. %, 0.01 to 15 wt. %, 0.01 to 10 wt. %, or 0.01 to 5 wt. %. The incorporation of the additives can be carried out by any known process such as, for example, by dry blending, by extruding a mixture of the various constituents, by the conventional masterbatch technique, or the like.

According to various embodiments, the grafted polyethylenes of the present disclosure may be used to form an extruded article such as a blown or cast film, a foam, or a molded article. For example, the grafted polyethylene may also be used as a blend component in impact modification of an engineering thermoplastic. Polyethylenes may be used to form a foam, wherein the grafted polyethylenes can be combined with additives used to control foam properties to form foams of various shapes. In some embodiments, the foam may be extruded, such as from an extruder, as is known to those of ordinary skill in the art.

### Test Methods

### Density

Samples for density measurement are prepared according to ASTM D 1928. Polymer samples are pressed at 190° C. and 30,000 psi for three minutes, and then at 21° C. and 207 MPa for one minute. Measurements are made within one hour of sample pressing using ASTM D792, Method B.

Melt Index (I₂ and I₁₀)

Melt index I₂ and I₁₀, (grams/10 minutes or dg/min) were measured in accordance with ASTM D 1238, Condition 190° C./2.16 kg and 190° C./10 kg, respectively, using Procedure D. The ratio is reported as I₁₀/I₂.

### Melt Strength

Melt strength was measured at 190° C. using a Goettfert Rheotens 71.97 (Goettfert Inc.; Rock Hill, S.C.), melt fed with a Goettfert Rheotester 2000 capillary rheometer equipped with a flat entrance angle (180 degrees) of length of 30 mm and diameter of 2 mm. The pellets were fed into the barrel (L=300 mm, Diameter=12 mm), compressed and allowed to melt for 10 minutes before being extruded at a constant piston speed of 0.265 mm/s, which corresponds to a wall shear rate of 38.2 s⁻¹ at the given die diameter. The extrudate was passed through the wheels of the Rheotens located at 100 mm below the die exit and was pulled by the wheels downward at an acceleration rate of 2.4 mm/s². The force (in cN) exerted on the wheels was recorded as a function of the velocity of the wheels (mm/s). Melt strength was reported as the plateau force (cN) before the strand breaks or has significant draw resonance.

### Dynamic Mechanical Spectroscopy (DMS)

The melt rheology was analyzed by DMS, using an Advanced Rheometric Expansion System (ARES) rheometer under a nitrogen purge. A constant temperature dynamic frequency sweep, in the range of 0.1 to 100 rad/s, was performed under nitrogen, at 190° C. The sample was placed on the lower plate and allowed to soften for five minutes. The plates were then closed to a gap of “2.0 mm,” and the sample trimmed to “25 mm” in diameter. The sample was allowed to equilibrate at 190° C. for five minutes, before starting the test. The complex viscosity was measured at a constant strain amplitude of 10%. The stress response was analyzed in terms of amplitude and phase, from which the storage modulus (G′), loss modulus (G″), dynamic viscosity η*, and tan delta could be calculated. V0.1 is the viscosity at 0.1 rad/s (190° C.), and V100 is the viscosity at 100 rad/s (190° C.) were recorded. V0.1/V100 was designated at the rheology ratio.

### Dynamic Mechanical Thermal Analysis (DMTA)

DMTA measurements were performed on an ARES-G2 instrument under a nitrogen purge. Samples of about 3 mm thickness were die cut to a rectangular specimen of 12.7 mm×30 mm dimension. A temperature sweep was performed in the torsional mode from 30° C. to 140° C. in 5° C. increments. A frequency of 10 rad/s was used. The strain amplitude was adjusted (from 0.1% to 5%) to control the torque response. The storage modulus was measured as a function of temperature. Samples were dried at 70° C.-80° C. for 8 to 10 hours prior to testing.

### EXAMPLES

Embodiments will be further clarified by the following examples.

The following examples were prepared using various components. Table 1 sets forth the trade names of polyethylene components and the properties of those components. These polymers are all supplied by Dow Inc., (Midland, MI).

TABLE 1
Polyethylene resins

| | | Melt | | |
|---|---|---|---|---|
| | | Index (I₂) | Density | |
| Trade Name | Type of Polyethylene | g/10 mins | (g/cc) | Comonomer |
| DOW ™ DMDA- | HDPE | 8.5 | 0.965 | |
| 8007 | | | | |
| DOW ™ DMDA | HDPE | 65 | 0.952 | |
| 8965 | | | | |
| INFUSE ™ 9530 | Olefin Block Copolymer (OBC) | 5 | 0.887 | |
| INFUSE ™ 9807 | OBC | 15 | 0.866 | |
| ENGAGE ™ 8842 | Ethylene-Octene Polyolefin | 1 | 0.857 | |
| | Elastomer (POE) | | | |
| AMPLIFY ™ EA103 | Ethylene Ethyl Acrylate copolymer | 21MI, | 0.930 | 19.5 wt % ethyl |
| | | | | acrylate |
| | | | | comonomer |
| AFFINITY ™ | Ethylene Octene copolymer | 1000 | 0.88 | |
| GA1875 | | | | |
| NUCREL 960 | Ethylene Methacrylic Acid | 60 | 0.940 | 15 wt % |
| | Copolymer | | | methacrylic acid |
| ELVAX ™ 40 W | Ethylene Vinyl Acetate Copolymer | 52 | 0.965 | 40 wt % vinyl |
| | (EVA) | | | acetate |

TABLE 2
Acrylates and Carboxylates

| Trade Name | Component Type | Supplier | CAS Number |
|---|---|---|---|
| React-Rite ZDA | Zinc Diacrylate | ICT Chemicals | CAS# 14643.87-9 |
| Zinc Stearate | Zinc Stearate (pastille) | Struktol | CAS# 557-05-1 |
| Zinc Laurate | Zinc Laurate(pastille) | Struktol | CAS# 2452-01-9 |
| ZEH | Zinc 2-ethylhexanoate | Struktol | CAS# 136-53-8 |
| Dibutyl tin dilaurate | Dibutyl tin dilaurate | Sigma Aldrich | CAS# 77-58-7 |
| Sodium Acrylate | Sodium Acrylate | Sigma Aldrich | CAS# 7446-81-3 |

### Masterbatches

Several masterbatches were prepared to facilitate handling of the metal acrylate and aid dispersion.

For Zinc Diacrylate (ZnDA) Masterbatch A, a 70% active zinc diacrylate masterbatch was compounded with a 20 Mooney (ML 1+4 @125° C.) EPR rubber (70% Ethylene) compositions using a batch mixer at temperatures not exceeding 100° C. The masterbatch was transferred to a kneader extruder and pelletized for further use.

For Zinc Diacrylate masterbatches B and C, a 50% active zinc diacrylate masterbatches was prepared based on the formulations outlined below in a twin screw extruder at temperatures below 160° C.
ZnDA Masterbatch B=HDPE 8965 50:50 by weight, batch mixer
ZnDA Masterbatch C=AFFINITY™ GA1875 50:50 by weight, batch mixer

### Batch Mixer Grafting

Grafting of small samples was done on a RS5000 batch mixer from Rheometers Services Inc. The small bowl, which can mix batches up to 45 g, was used, with roller blade rotors. After initial fluxing of the base polymer for a minute, the remaining ingredients in the formulation were loaded in the mixer at a low speed. Following incorporation of all other ingredients, a rotor speed of 50 rpm and a bowl temperature of 245° C. was used. The mixing was continued for an additional 8 minutes. After mixing, the batch was collected on a glass reinforced Teflon sheet, pressed into a flat ‘patty’ on a compression molder and cooled to ambient temperature.

Depending on the individual ingredient different methods of addition to the mixer were used. All pellets and pastilles were directly added. When powdered ZnDA was used it was weighed on a film made out of the base resin and then rolled. This roll was then added to the mixer. The DBTDL was soaked onto the pellets overnight prior to use. The zinc octoate in liquid form was pre-weighed in a syringe and injected into the mixer.

### Twin Screw Extruder Grafting

When a twin screw was used the grafting reaction was performed on a 26 mm co-rotating twin screw extruder (ZSK-26 from Coperion Corp.). The extruder was configured with 15 barrels (60 L/D). The maximum screw speed was 1200 rpm, and the maximum motor output was 40 HP. The extruder was equipped with “loss-in-weight feeders.” All ingredients were pre-blended and fed to the extruder. Nitrogen at 5 Standard Cubic Feet per Hour (SCFH) was used to purge first barrel section to maintain an inert atmosphere and minimize oxidation. A vacuum (˜15 Hg) was pulled on Barrel 13. A two-hole die was used to produce strands which were cut into pellets using a strand cutter. A run rate of 12 lbs./hr. and a screw speed of 450 rpm was used. Barrels 1 was water cooled, Barrels 2-5 were maintained at 170 C, Barrels 6-11 were maintained at 240° C. and Barrels 12-15 were maintained at 190° C.

The examples below demonstrate the effect of grafting zinc diacrylate onto various polyolefins in presence of a zinc or sodium salt.

The effect of adding zinc stearate, zinc laurate or zinc octoate during zinc diacrylate grafting onto OBC is shown in Table 3 (Comparative Examples CE1-3 and Inventive Examples IE4-8). This results in much higher low shear viscosity (V0.1) and rheology ratio compared to the base resin. Further, dibutyltin dilaurate either when used alone or in combination with zinc stearate also has a similar effect on low shear viscosity and rheology ratio. Table 3 (Comparative Example CE9 and Inventive Examples IE10-11) also shows grafting of sodium acrylate in the presence of metal carboxylates onto HDPE and the changes in rheological properties. The Examples of Table 3 were all carried out in a batch mixer.

TABLE 3
Zinc Diacrylate & Sodium acrylate grafted onto OBC and HDPE in a batch mixer

| EXAMPLE | CE1 | CE2 | CE3 | IE4 | IE5 | IE6 | IE7 | IE8 | CE9 | IE10 | IE11 |
|---|---|---|---|---|---|---|---|---|---|---|---|
| Properties | | | | | | | | | | | |
| INFUSE 9807 | 100 | 100 | 100 | 100 | 100 | 100 | 100 | 100 | | | |
| DMDA 8007 | | | | | | | | | 100 | 100 | 100 |
| ZnDA | | 4.25 | 4.25 | 4.25 | 4.25 | 4.25 | 4.25 | 4.25 | | | |
| masterbatch A | | | | | | | | | | | |
| DBTDL | | | | | | | 0.25 | 0.25 | | | 0.25 |
| Zinc Stearate | | | | 1 | | | | 1 | | 1 | 1 |
| Zinc Laurate | | | | | 1 | | | | | | |
| Zinc 2- | | | | | | 1 | | | | | |
| ethylhexanoate | | | | | | | | | | | |
| Stearic Acid | | | 1 | | | | | | | | |
| Sodium Acrylate | | | | | | | | | | 3 | 3 |
| powder | | | | | | | | | | | |
| Properties | | | | | | | | | | | |
| Visc, 0.1 1/s, | 431 | 1210 | 1022 | 3465 | 2111 | 2478 | 3923 | 7758 | 1025 | 4839 | 4987 |
| 190° C., Pas | | | | | | | | | | | |
| Visc, 100 1/s, | 277 | 387 | 376 | 457 | 437 | 458 | 494 | 553 | 474 | 662 | 686 |
| 190° C., Pas | | | | | | | | | | | |
| Rheology | 1.6 | 3.1 | 2.7 | 7.6 | 4.8 | 5.4 | 7.9 | 14.0 | 2.2 | 7.3 | 7.3 |
| Ratio | | | | | | | | | | | |

Table 4 shows the effect of grafting zinc diacrylate onto an OBC (Comparative Examples CE12, CE16 and CE17 and Inventive Examples CE13-IE15) and ethylene-octene POE copolymer (Comparative Examples CE18-CE19 and Inventive Example IE20) both with and without zinc stearate. Again, the combination of the zinc diacrylate and zinc stearate have a synergistic effect and the rheological changes are significantly greater versus using zinc diacrylate alone. Besides, low shear viscosity enhancement in melt strength is also seen. CE17 shows that the zinc stearate by itself has no effect. CE16 shows that similar effect cannot be achieved with peroxide (note peroxide cannot be used at high levels as it will lead to gel formation).

TABLE 4
Zinc Diacrylate grafted onto OBC and POE in a twin screw extruder

| EXAMPLE | CE12 | I13 | I14 | I15 | CE16 | CE17 | CE18 | CE19 | I20 |
|---|---|---|---|---|---|---|---|---|---|
| Components | | | | | | | | | |
| INFUSE 9530 | 100 | 100 | 100 | 100 | 100 | 100 | | | |
| ENGAGE 8842 | | | | | | | 100 | 100 | 100 |
| Active ZnDA | | 3 | 3 | 3 | | | | 3 | 3 |
| content | | | | | | | | | |
| Zinc Stearate | | 1 | 1 | | | 3 | | | 1 |
| Luperox 101 | | | 0.03 | | 0.15 | | | | |
| ZnDA Masterbatch | A | A | A | A | | | | A | C |
| Properties | | | | | | | | | |
| I2, g/10 min | 5 | 0.85 | 0.49 | 2.68 | 6.35 | 7.28 | 1 | 0.5 | 0.27 |
| I10, g/10 min | | 15.41 | 10.33 | 29.9 | 60.4 | 53.25 | | 10.01 | 5.9 |
| I10/I2 | | 18.1 | 21.1 | 11.2 | 9.5 | 7.3 | | 18.6 | 21.9 |
| Viscosity, 0.1 | 1323 | 10043 | 16856 | 5434 | 1803 | 992 | 9398 | 13343 | 20032 |
| 1/s, 190° C., Pas | | | | | | | | | |
| Viscosity, 100 | 687 | 777 | 750 | 678 | 442 | 547 | 1506 | 883 | 904 |
| 1/s, 190° C., Pas | | | | | | | | | |
| Rheology Ratio | 1.9 | 12.9 | 22.5 | 8.0 | 4.1 | 1.8 | 6.2 | 15.1 | 22.2 |
| tan d @ 0.1 s⁻¹, | 110 | 1.73 | 1.05 | 2.55 | 14.55 | 128.4 | 7.33 | 1.77 | 1.4 |
| 190° C. | | | | | | | | | |
| tan d @ 100 s⁻¹, | 1.73 | 1.01 | 0.95 | 1.19 | 1.43 | 1.79 | 0.92 | 0.93 | 0.84 |
| 190° C. | | | | | | | | | |
| Melt Strength, | 0.65 | 10.5 | 8.7 | 5.0 | 1.7 | NM | NM | NM | NM |
| 190° C., cN | | | | | | | | | |

Table 5 shows the effect of grafting zinc diacrylate onto HDPE (Comparative Examples CE21-23. CE28, and CE29 and Inventive Examples IE24-27) both with and without zinc stearate using a twin screw extruder. Again, the combination of the zinc diacrylate and zinc stearate have a synergistic effect and the rheological changes are significantly greater versus using zinc diacrylate alone, low shear viscosity enhancement in melt strength is also seen. CE29 shows that the zinc stearate by itself has no effect. CE28 shows that a similar effect cannot be achieved with peroxide (note peroxide cannot be used at high levels because it will lead to gel formation) and the viscosity is comparable when the melt strength is lower.

TABLE 5
Zinc Diacrylate grafted onto HDPE in a twin screw extruder

| Example | CE21 | CE22 | CE23 | IE24 | IE25 | IE26 | IE27 | CE28 | CE29 |
|---|---|---|---|---|---|---|---|---|---|
| Components | | | | | | | | | |
| DMDA 8007 | 100 | 100 | 100 | 100 | 100 | 100 | 100 | 100 | 100 |
| Active ZnDA content | | 6 | 3 | 3 | 3 | 1.5 | 0.75 | | |
| Zinc Stearate | | | | 1 | 3 | 0.5 | 0.25 | | 3 |
| Luperox 101 | | | | | | | | 0.1 | |
| ZnDA Masterbatch | | A | B | B | A | B | B | | |
| Properties | | | | | | | | | |
| I2 | 8.5 | 0.51 | 1.27 | 0.34 | NM | 1.01 | 0.68 | 1.56 | 7.82 |
| I10 | | 15.5 | 23.29 | 11.64 | NM | 18.82 | 12.58 | 23.07 | 64.6 |
| I10/I2 | | 30.3 | 18.3 | 34.2 | NM | 18.6 | 18.5 | 14.8 | 8.3 |
| Viscosity, 0.1 | 1025 | 24524 | 13902 | 26884 | 30688 | 15382 | 13560 | 13433 | 1359 |
| 1/s, 190° C., Pas | | | | | | | | | |
| Viscosity, 100 | 474 | 901 | 843 | 1040 | 965 | 895 | 847 | 790 | 468 |
| 1/s, 190° C., Pas | | | | | | | | | |
| Rheology Ratio | 2.2 | 27.2 | 16.5 | 25.9 | 31.8 | 17.2 | 16.0 | 17.0 | 2.9 |
| tan δ @ 0.1 s⁻¹, | 36.87 | 1.08 | 1.58 | 1.34 | 1.33 | 1.73 | 1.68 | 2.40 | 17.22 |
| 190° C. | | | | | | | | | |
| tan δ @ 100 s⁻¹, | 1.90 | 0.97 | 1.04 | 0.85 | 0.81 | 0.96 | 0.99 | 0.97 | 1.74 |
| 190° C. | | | | | | | | | |
| Melt Strength, | <1 | 6.0 | 4.5 | 7.1 | 7.3 | 5.2 | 8.8 | 3.2 | NM |
| 190° C., cN | | | | | | | | | |

Table 6 shows the effect of grafting zinc diacrylate onto polar ethylene copolymers (Comparative Examples CE30-31, and CE34-36 and Inventive Examples IE33 and IE37-41) both with and without a metal carboxylate (in the examples, DBTDL & zinc stearate) using a batch mixer. The polar ethylene copolymers used were ethylene-ethyl acrylate, ethylene-methacrylic acid copolymer and ethylene-vinyl acetate copolymer. Again, the combination of the zinc diacrylate and zinc stearate have a synergistic effect and the rheological changes are significantly greater versus using zinc diacrylate (or in combination with DBTDL) alone. CE36 shows that the zinc stearate by itself has no effect.

TABLE 6
Zinc Diacrylate grafted onto Polar Ethylene Copolymers in a batch mixer

| EXAMPLES | CE30 | CE31 | IE32 | IE33 | CE34 | CE35 | CE36 | IE37 | IE38 | IE39 | IE40 | IE41 |
|---|---|---|---|---|---|---|---|---|---|---|---|---|
| Components | | | | | | | | | | | | |
| AMPLIFY | 100 | 100 | 100 | 100 | | | | | | | | |
| EA103 | | | | | | | | | | | | |
| NUCREL 960 | | | | | 100 | 100 | 100 | 100 | 100 | | | |
| ELVAX 40W | | | | | | | | | | 100 | 100 | 100 |
| ZnDA powder | | 3 | 3 | 8 | | 3 | | 3 | 3 | | 5 | 5 |
| DBTDL | | | | | | | | | 0.25 | | | |
| Zinc Stearate | | | 1 | 2.65 | | | 3 | 1 | 1 | | | 1.67 |
| Properties | | | | | | | | | | | | |
| Visc, 0.1 1/s, | 1780 | 9743 | 35789 | 105065 | 173 | 6524 | 200 | 6736 | 7846 | 202 | 848 | 1474 |
| 190° C., Pas | | | | | | | | | | | | |
| Visc, 100 1/s, | 184 | 284 | 389 | 591 | 98 | 285 | 104 | 305 | 324 | 105 | 160 | 142 |
| 190° C., Pas | | | | | | | | | | | | |
| Rheology | 9.7 | 34.3 | 92.0 | 177.8 | 1.8 | 22.9 | 1.9 | 22.1 | 24.2 | 1.9 | 5.3 | 10.4 |
| Ratio | | | | | | | | | | | | |

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A grafted polyethylene comprising the reaction product:
a polyethylene having a melt index (at 190° C., 2.16 kg) of at least 0.75 g/10 min;
from 0.5 wt. % to 10 wt. % of metal acrylate or metal methacrylate at least partially grafted on the polyethylene; and
from 0.1 wt. % to 10 wt. % of one or more metal carboxylates, wherein the metal carboxylate does not have any terminal unsaturation

2. The grafted polyethylene of claim 1, wherein the metal of the metal acrylate or metal methacrylate comprises zinc, sodium, potassium, calcium, magnesium, lithium, or combinations thereof.

3. The grafted polyethylene of claim 1, wherein the grafted polyethylene comprises zinc diacrylate.

4. The grafted polyethylene of claim 1, wherein the grafted polyethylene comprises sodium acrylate.

5. The grafted polyethylene of claim 1, wherein the metal carboxylate comprises a hydrocarbon chain of at least 8 carbons.

6. The grafted polyethylene of claim 1, wherein the metal carboxylate comprises metal stearate, metal laurate, metal octoate, dibutyltin dilaurate, or combinations thereof.

7. The grafted polyethylene of claim 1, further comprising a peroxide.

8. The grafted polyethylene of claim 1, wherein the polyethylene comprises high density polyethylene (HDPE).

9. The grafted polyethylene of claim 1, wherein the polyethylene comprises an olefin block copolymer (OBC).

10. The grafted polyethylene of claim 1, wherein the polyethylene comprises a polar ethylene copolymer.

11. An article comprising the grafted polyethylene of claim 1.

12. The article of claim 11, wherein the article is an extruded monolayer or multilayer cast or blown film, an extruded fiber, a molded or extruded foam, or a molded article produced from thermoforming or blow molding.

13. The article of claim 11, comprising the grafted polyethylene.

14. A process of producing the grafted polyethylene of claim 1 comprising:
blending the polyethylene, the metal acrylate or metal methacrylate, and the metal carboxylate to produce the grafted polyethylene using a batch or a continuous mixer.
